(19) United States
(12) Patent Application Publication
(10) Pub. No.: US 2002/0146534 A1
(43) Pub. Date: Oct. 10, 2002

(54) Moisture impermeable printed article

(76) Inventor: Mark S. Kaufman, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 09/827,988

(22) Filed: Apr. 6, 2001

(51) Int. Cl. B32B 3/00

(52) U.S. Cl. 428/88; 428/96; 428/195; 428/196; 428/197

(57) ABSTRACT

An article selected from the group including a bar mat and a rug includes a top layer of non-absorbent material, an intermediate layer of liquid absorbent material for absorbing the sublimation inks to provide high definition printing for line art or four color process graphics including reproduction of photographs and lithographs. The article further includes a bottom waterproof layer interposed with the intermediate layer and having a non-slippery surface.

### FIELD OF THE INVENTION

The invention relates to an easily displaceable printed article used for wet environments. Particularly, the invention relates to a bar mat, table cloth and the like having a top, which is printed with logo or any other commercial indicia, and a water impermeable non-slippery bottom.

### BACKGROUND OF THE INVENTION

The popularity of printed articles, such as a bar mat, a rug, and the like, is enormous primarily because of their practicality and esthetic appeal. Such well-known processes as silk screening techniques can manufacture the printed articles. Typically, images produced by these techniques may be not entirely satisfactory and tend to have a relatively low definition. Also, these techniques typically are not adapted to produce the articles, as disclosed here, by the four color process printing technique which would be effective for high quality photograph reproduction on an article.

A sublimation printing technique, which is capable of transferring a high definition design wherein no discernable dot pattern is apparent, has been developed to overcome the disadvantages of the silk printing techniques. In fact, using this technique, the four color process printing has been found to be possible. In addition, due to the sublimation technique, the printing can be produced in full bleed.

U.S. Pat. No. 5,486,500 to Kaufman discloses an article, such as a towel, manufactured in accordance with the sublimation printing technique. The thus produced article comprises two faces or surfaces, wherein one of the faces receives a relatively non-absorbent material capable of being dyed.

U.S. Pat. 4,409,275 to Samovich discloses a decorative article substrate having a top face, which is comprised of a top layer of clear film, a lower layer of foam and a substrate interposed with the foam and having a bottom face which is coated with a metallized insulator layer. Encapsulated between the top and lower layers is a decorative printing layer allowing the decorative article to be applied for a variety of fields, one of which can be home furnishing. However, the thus manufactured decorative article may be rather rigid and moisture permeable.

U.S. Pat. 4,878,974 discloses a moisture-impermeable film adhered to a woven or non-woven material. The film is made of an ethylenepropylene-diene copolymer and an ethylene-propylene-diene polymer. While these materials suit well for the purposes of this patent, they are hardly suitable for producing a decorative article, such as a tablecloth, rug and the like.

It is, therefore, desirable to produce an article used for wet environments, such as a bar mat, and having a top that has an image printed in accordance with the sublimation printing technique and a moisture-impermeable bottom of polymeric material. An article used for wet environments and having a printed polyester top, which is interposed with a moister-impermeable nor slippery bottom, is also desirable.

### SUMMARY OF THE INVENTION

This is obtained by an article selected from the group consisting of a bar mat, tablecloth, a rug, a decorative cover and the like and made from a composite. The composite includes a decorative top layer having a printed image, and a non-slippery moisture-impermeable bottom layer, which is preferably made of polyurethane, vinyl and etc.

According to one aspect of the invention, the article is made of material which can act as a substrate for printing by sublimation printing techniques. Generally, the bottom layer, in accordance with the invention, can melt at temperatures at which the top layer melts. Preferably, the bottom layer melts at temperatures at least equal to 400° and is attached to the substrate.

In accordance with another aspect of the invention, the article has a face imprinted with logo or the like which is accomplished by sublimation printing techniques capable of transferring a high definition design. The face further has an absorbent material attached to a non-slippery water-repellant bottom layer. Alternatively, the face can be sprayed with a variety of chemicals enhancing the absorption of the face layer.

According to another aspect of the invention, the article has a substrate, a non-slippery moisture-impermeable back-up layer, which is applied to the substrate by means of the four color process, and a transparent outer layer. All of the layers are attached to one another to form an article in accordance with the invention.

It is therefore an object of the invention to overcome the disadvantages of the prior art.

Still another object of the invention is to provide an article used for wet environments and having a water-impermeable back-up layer and a top layer with applied to it printing which is accomplished by means of sublimation printing techniques.

Yet another object of the invention is to provide an article having a top, which carries an image having photograph reproduction quality and brilliance, while maintaining ample article absorbency, and a bottom water-impermeable non-slippery bottom.

Still a further object of the invention is to provide an article having a top transparent layer, a bottom water-impermeable layer and a layer which is placed between the bottom and top layers and imprinted with logo.

### BRIEF DESCRIPTION OF THE DRAWINGS

The above and other objects, features and advantages will become more readily apparent from the specific description of the preferred embodiment accompanied by the attached drawings, in which:

FIG. 1 is a perspective view of an article in accordance with the present invention.

FIG. 2 is a cross-sectional view of the article shown in FIG. 1.

FIG. 3 is a cross-sectional view of another embodiment of the article shown in FIG. 1.

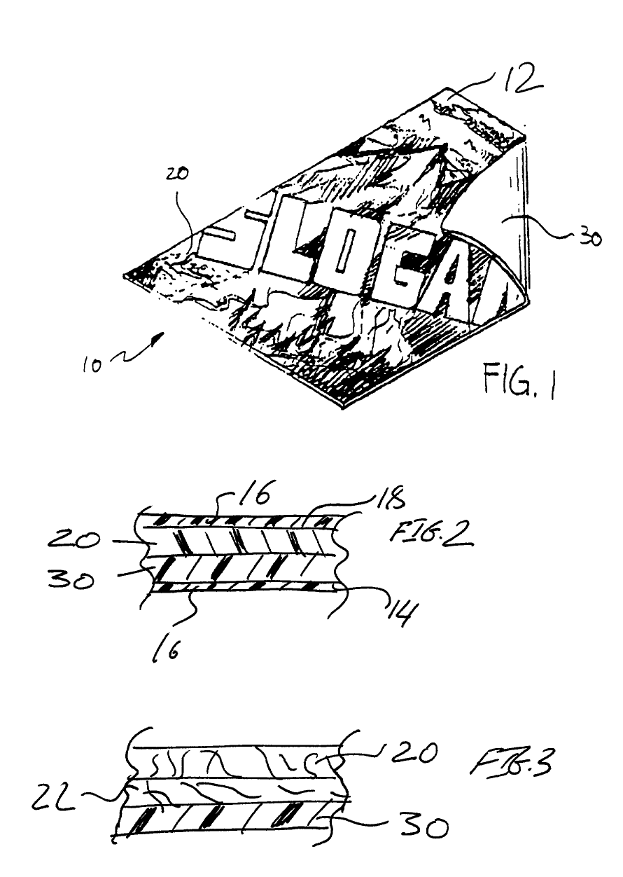

### DETAILED DESCRIPTION OF THE DRAWINGS

Referring to the drawings, a bar mat in accordance with the invention is generally indicated by the reference numeral 10. It should be noted that the present invention is described as a bar mat for the sake of convenience, which is intended to describe its characteristics in addition to its function, and that the invention is generally relates to any piece of material useful as a bar mat, and having the desired characteristics. In fact, it is contemplated that any object for which ornamentation and waterproofness are desired, such as rugs and even certain types of garment, are included in the invention, and can functionally and structurally relate to the bar mat 10.

Bar mat 10 is made from a web or sheet like piece of material which can be used for covering wet surfaces, such as bar tables, restaurant and cafeteria tables, and comprises at least two layers 20 and 30. A shape of the article 10 varies in accordance with its particular functional application. A face 12 of the top layer 20 is a printing receiving face preferably comprised of a relatively non-absorbent material capable of being dyed in a sublimation printing process and selected from the group consisting of polyester, nylon, acrylic, and combinations thereof. Most preferably, the non-absorbent material is polyester. The relatively non-absorbent material is characterized by a moisture regain of less than about 3%.

The quality of image definition directly depends upon the percentage of non-absorbent material comprised in the topface 12. Hence, it is preferred that the top surface is made of one hundred percent non-absorbent material.

Face 22, opposite the face 12, of the top layer 20 typically comprises a material capable of absorbing liquids; such material can be any natural or synthetic material. Preferably, the absorbent material is selected from the group consisting of cotton, linen, and the combination thereof, which can, but does not have to, include a small percentage of a non-absorbent material. The moisture regain of the face 22 should be at least 3.5%, more preferably 5.5%. Opposite face 12 and 22 can be knitted or woven together so as to form the top layer 20. Furthermore, alternatively to the above disclosed structure, a variety of chemicals known for enhancing the absorption characteristics can be sprayed upon the face 22.

Layer 30, opposite layer 20, should be made of a material capable of preventing water from penetration into the top layer 20. Such material can be any synthetic material which is easily adhered to the top layer and provides a reliable friction with the surface that is to be covered by the bar mat. Such material can be vinyl or urethane that can be easily attached to the layer 20 and melt at about 400° K to withstand heat along with pressure or vacuum necessary for application of the sublimation inks.

In accordance with one of the embodiments of the invention, the bottom layer 30 can be made of transparent vinyl 16. Having such structure it is possible to have an image printed on opposite sides of the top layer 20, provided that the non-absorbent face 22 is not used. In addition, such transparent layer 16 may be sealed to an outer side 18 of the top layer to increase durability of the entire article. Alternatively, the transparent layer 16 can be attached to an outer side 14 of the bottom layer 30. In this case, the outer side 14 can be provided with printed legends which would be visible through the layer 16.

Bar mat 10 can be formed with the top layer 12 in any desired color and combinations of different colors. As noted above, printing is applied by sublimation printing techniques. The printing can be line art or four color process graphics including reproduction of photographs; it can comprise logos, lettering, images, or their combinations. Further, the printing can be fill-bleed printing.

The top layer 20 may have separate layers, wherein a top printing layer is made of a combination including predominantly a non-absorbent material and a relatively small percentage of any suitable synthetic material, and the inner layer may be identical to the non-absorbent face 22. As a consequence, instead of weaving or knitting these opposite layers together, it would be possible to simultaneously bond these two layers together with the bottom layer 30.

Although the invention has been described with reference to a particular arrangements of parts, features and the like, these are not intended to exhaust all possible arrangements or features, and indeed many other modifications and variations will be ascertainable to those of skill in the art.

What is claimed is:

1. An article selected from the group consisting of a bar mat, tablecloth, rug and the like comprising:
a top layer comprised of an outer face of a relatively absorbent material and an inner face of a relatively non-absorbent material, the top layer being able to receive printing by sublimation printing techniques, having four color process printing applied thereon by sublimation of sublimation inks; and
a bottom layer interposed with the intermediate layer, the bottom layer being water-impermeable and having a non-slippery outer surface.

2. The article defined in claim 1 wherein the bottom layer melts at temperatures of at least 400° F.

3. The article defined in claim 1 wherein the bottom layer is selected from the group consisting of vinyl and urethane.

4. The article defined in claim 1 wherein the bottom layer is transparent.

5. The article defined in claim 1 wherein the absorbent material is comprised of polyester.

6. The article defined in claim 1 wherein the printing is formed by photographic or lithographic techniques.

7. The article defied in claim 1 wherein the absorbent material is selected from the group consisting of cotton and linen.

8. The article defined in claim 1 wherein the printing comprises lettering, images, or combination thereof.

9. The article defied in claim 1 wherein the printing is produced full bleed.

10. An article selected from the group consisting of a bar mat, tablecloth, rug and the like comprising:
a top layer comprised of a relatively absorbent material and being able to receive printing by sublimation printing techniques, having four color process printing applied thereon by sublimation of sublimation inks; and
a bottom layer interposed with the intermediate layer, the bottom layer being transparent, water-impermeable and having a non-slippery outer surface.
